(19) United States
(12) Patent Application Publication
(10) Pub. No.: US 2014/0032714 A1
(43) Pub. Date: Jan. 30, 2014

(54) METHOD AND APPARATUS FOR PUBLISHING LOCATION INFORMATION FOR A CONTENT OBJECT

(71) Applicant: Interdigital Patent Holdings, Inc., Wilmington, DE (US)

(72) Inventors: Hang Liu, North Potomac, MD (US); Dan Zhang, Bridgeport, PA (US)

(73) Assignee: INTERDIGITAL PATENT HOLDINGS, INC., Wilmington, DE (US)

(21) Appl. No.: 13/952,285

(22) Filed: Jul. 26, 2013

Related U.S. Application Data
(60) Provisional application No. 61/676,525, filed on Jul. 27, 2012.

(51) Int. Cl. H04L 29/08

(52) U.S. Cl. CPC H04L 67/18
USPC 709/217

(57) ABSTRACT

A method and apparatus are described for publishing location information for a content object. A content router (CR) may desire to publish location information for a content object and determine whether a utility function (e.g., popularity) of the content object is greater than a threshold. The CR may advertise the location information to a plurality of CRs on a condition that the utility function is greater than the threshold. Alternatively, the CR may provide the location information to a resolver as determined by a distributed hash table (DHT) scheme on a condition that the utility function is not greater than the threshold. The length of a name of the content object may be based on the popularity of the content object. Names of less popular content objects may be aggregated to reduce overhead.

### CROSS REFERENCE TO RELATED APPLICATIONS

This application claims the benefit of U.S. Provisional Application Ser. No. 61/676,525 filed Jul. 27, 2012, the content of which is incorporated herein by reference in their entirety.

### BACKGROUND

The Internet may be used to facilitate content distribution and retrieval. In existing Internet protocol (IP) networks, computing nodes, (e.g., terminals, servers, and the like), may be interconnected by establishing communications using the IP addresses of these nodes. However, in information-centric networks (ICNs), users are interested in the content itself, rather than where the content is stored. Thus, content distribution and retrieval may be performed by ICNs based on names (i.e., identifiers (IDs)), of content objects, rather than IP addresses. This discrepancy between the existing IP networks and ICNs may cause inefficiencies in the networks and user applications. Thus, it would be desirable to optimize content naming schemes and content routing schemes used by ICNs.

### SUMMARY

A method and apparatus are described for publishing location information for a content object. A content router (CR) may desire to publish location information for a content object and determine whether a utility function (e.g., popularity) of the content object is greater than a threshold. The CR may advertise the location information to a plurality of CRs on a condition that the utility function is greater than the threshold. Alternatively, the CR may provide the location information to a resolver as determined by a distributed hash table (DHT) scheme on a condition that the utility function is not greater than the threshold. The length of a name of the content object may be based on the popularity of the content object. Names of less popular content objects may be aggregated to reduce overhead.

### BRIEF DESCRIPTION OF THE DRAWINGS

A more detailed understanding may be had from the following description, given by way of example in conjunction with the accompanying drawings wherein:

FIG. 1A shows an example communications system in which one or more disclosed embodiments may be implemented;

FIG. 1B shows an example wireless transmit/receive unit (WTRU) that may be used within the communications system shown in FIG. 1A;

FIG. 1C shows an example radio access network and an example core network that may be used within the communications system shown in FIG. 1A;

FIG. 2 shows an example of a flooding-based content-centric network (FB-CCN);

FIG. 3 shows an example of a distributed hash table (DHT) network;

FIG. 4 is a flow diagram of an example hybrid content publishing procedure for a content router (CR) to publish the location reachability information of a content object;

FIG. 5 is a flow diagram of an example procedure for a CR to forward a request for a content object;

FIG. 6 is a flow diagram of an example procedure used to determine whether to aggregate the content names before publishing them using a flooding scheme or DHT scheme; and

FIG. 7 shows an example block diagram of a content router (CR).

### DETAILED DESCRIPTION

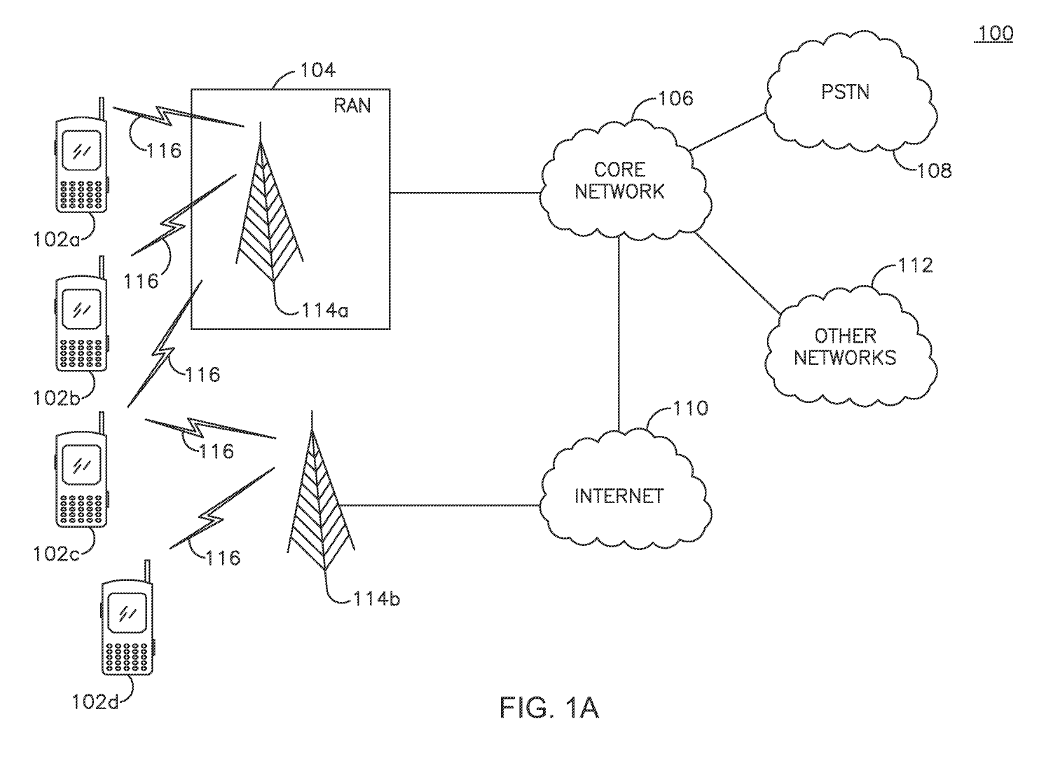

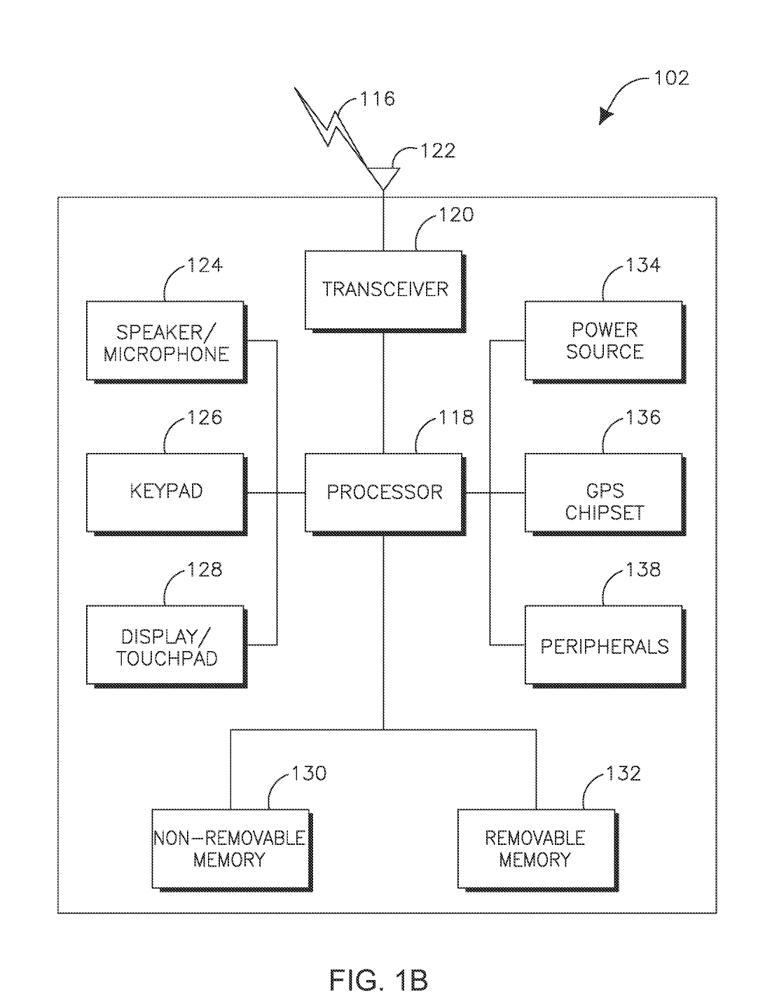

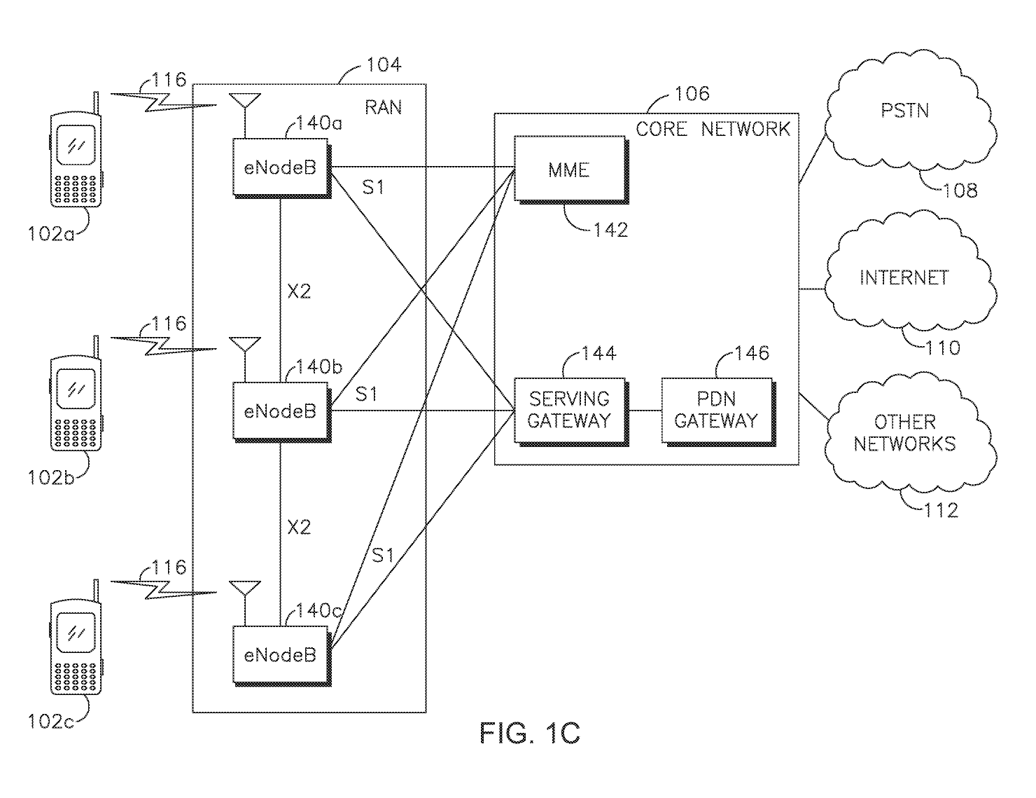

FIG. 1A shows an example communications system 100 in which one or more disclosed embodiments may be implemented. The communications system 100 may be a multiple access system that provides content, such as voice, data, video, messaging, broadcast, and the like, to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), and the like.

As shown in FIG. 1A, the communications system 100 may include wireless transmit/receive units (WTRUs) 102a, 102b, 102c, 102d, a radio access network (RAN) 104, a core network 106, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d may be configured to transmit and/or receive wireless signals and may include user equipment (UE), a mobile station, a fixed or mobile subscriber unit, a pager, a cellular telephone, a personal digital assistant (PDA), a smartphone, a laptop, a netbook, a personal computer, a wireless sensor, consumer electronics, and the like.

The communications systems 100 may also include a base station 114a and a base station 114b. Each of the base stations 114a, 114b may be any type of device configured to wirelessly interface with at least one of the WTRUs 102a, 102b, 102c, 102d to facilitate access to one or more communication networks, such as the core network 106, the Internet 110, and/or the other networks 112. By way of example, the base stations 114a, 114b may be a base transceiver station (BTS), a Node-B, an evolved Node-B (eNB), a home Node-B (HNB), a home eNB (HeNB), a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104, which may also include other base stations and/or network elements (not shown), such as a base station controller (BSC), a radio network controller (RNC), relay nodes, and the like. The base station 114a and/or the base station 114b may be configured to transmit and/or receive wireless signals within a particular geographic region, which may be referred to as a cell (not shown). The cell may further be divided into cell sectors. For example, the cell associated with the base station 114a may be divided into three sectors. Thus, in one embodiment, the base station 114a may include three transceivers, i.e., one for each sector of the cell. In another embodiment, the base station 114a may employ multiple-input multiple-output (MIMO) technology and, therefore, may utilize multiple transceivers for each sector of the cell.

The base stations 114a, 114b may communicate with one or more of the WTRUs 102a, 102b, 102c, 102d over an air interface 116, which may be any suitable wireless communication link, (e.g., radio frequency (RF), microwave, infrared (IR), ultraviolet (UV), visible light, and the like). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104 and the WTRUs 102a, 102b, 102c may implement a radio technology such as universal mobile telecommunications system (UMTS) terrestrial radio access (UTRA), which may establish the air interface 116 using wideband CDMA (WCDMA). WCDMA may include communication protocols such as high-speed packet access (HSPA) and/or evolved HSPA (HSPA+). HSPA may include high-speed downlink packet access (HSDPA) and/or high-speed uplink packet access (HSUPA).

In another embodiment, the base station 114a and the WTRUs 102a, 102b, 102c may implement a radio technology such as evolved UTRA (E-UTRA), which may establish the air interface 116 using long term evolution (LTE) and/or LTE-advanced (LTE-A).

In other embodiments, the base station 114a and the WTRUs 102a, 102b, 102c may implement radio technologies such as IEEE 802.16 (i.e., worldwide interoperability for microwave access (WiMAX)), CDMA2000, CDMA2000 1X, CDMA2000 evolution-data optimized (EV-DO), Interim Standard 2000 (IS-2000), Interim Standard 95 (IS-95), Interim Standard 856 (IS-856), global system for mobile communications (GSM), enhanced data rates for GSM evolution (EDGE), GSM/EDGE RAN (GERAN), and the like.

The base station 114b in FIG. 1A may be a wireless router, HNB, HeNB, or AP, for example, and may utilize any suitable RAT for facilitating wireless connectivity in a localized area, such as a place of business, a home, a vehicle, a campus, and the like. In one embodiment, the base station 114b and the WTRUs 102c, 102d may implement a radio technology such as IEEE 802.11 to establish a wireless local area network (LAN). In another embodiment, the base station 114b and the WTRUs 102c, 102d may implement a radio technology such as IEEE 802.15 to establish a wireless personal area network (WPAN). In yet another embodiment, the base station 114b and the WTRUs 102c, 102d may utilize a cellular-based RAT, (e.g., WCDMA, CDMA2000, GSM, LTE, LTE-A, and the like), to establish a picocell or femtocell. As shown in FIG. 1A, the base station 114b may have a direct connection to the Internet 110. Thus, the base station 114b may not be required to access the Internet 110 via the core network 106.

The RAN 104 may be in communication with the core network 106, which may be any type of network configured to provide voice, data, applications, and/or voice over Internet protocol (VoIP) services to one or more of the WTRUs 102a, 102b, 102c, 102d. For example, the core network 106 may provide call control, billing services, mobile location-based services, pre-paid calling, Internet connectivity, video distribution, and the like, and/or perform high-level security functions, such as user authentication. Although not shown in FIG. 1A, it will be appreciated that the RAN 104 and/or the core network 106 may be in direct or indirect communication with other RANs that employ the same RAT as the RAN 104 or a different RAT. For example, in addition to being connected to the RAN 104, which may be utilizing an E-UTRA radio technology, the core network 106 may also be in communication with another RAN (not shown) employing a GSM radio technology.

The core network 106 may also serve as a gateway for the WTRUs 102a, 102b, 102c, 102d to access the PSTN 108, the Internet 110, and/or other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and the Internet protocol (IP) in the TCP/IP suite. The networks 112 may include wired or wireless communications networks owned and/or operated by other service providers. For example, the networks 112 may include another core network connected to one or more RANs, which may employ the same RAT as the RAN 104 or a different RAT.

Some or all of the WTRUs 102a, 102b, 102c, 102d in the communications system 100 may include multi-mode capabilities, i.e., the WTRUs 102a, 102b, 102c, 102d may include multiple transceivers for communicating with different wireless networks over different wireless links. For example, the WTRU 102c shown in FIG. 1A may be configured to communicate with the base station 114a, which may employ a cellular-based radio technology, and with the base station 114b, which may employ an IEEE 802 radio technology.

FIG. 1B shows an example WTRU 102 that may be used within the communications system 100 shown in FIG. 1A. As shown in FIG. 11B, the WTRU 102 may include a processor 118, a transceiver 120, a transmit/receive element, (e.g., an antenna), 122, a speaker/microphone 124, a keypad 126, a display/touchpad 128, a non-removable memory 130, a removable memory 132, a power source 134, a global positioning system (GPS) chipset 136, and peripherals 138. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a microprocessor, one or more microprocessors in association with a DSP core, a controller, a microcontroller, an application specific integrated circuit (ASIC), a field programmable gate array (FPGA) circuit, an integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, the processor 118 and the transceiver 120 may be integrated together in an electronic package or chip.

The transmit/receive element 122 may be configured to transmit signals to, or receive signals from, a base station (e.g., the base station 114a) over the air interface 116. For example, in one embodiment, the transmit/receive element 122 may be an antenna configured to transmit and/or receive RF signals. In another embodiment, the transmit/receive element 122 may be an emitter/detector configured to transmit and/or receive IR, UV, or visible light signals, for example. In yet another embodiment, the transmit/receive element 122 may be configured to transmit and receive both RF and light signals. The transmit/receive element 122 may be configured to transmit and/or receive any combination of wireless signals.

In addition, although the transmit/receive element 122 is depicted in FIG. 1B as a single element, the WTRU 102 may include any number of transmit/receive elements 122. More specifically, the WTRU 102 may employ MIMO technology. Thus, in one embodiment, the WTRU 102 may include two or more transmit/receive elements 122, (e.g., multiple antennas), for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as UTRA and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), and the like), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station, (e.g., base stations 114a, 114b), and/or determine its location based on the timing of the signals being received from two or more nearby base stations. The WTRU 102 may acquire location information by way of any suitable location-determination method while remaining consistent with an embodiment.

The processor 118 may further be coupled to other peripherals 138, which may include one or more software and/or hardware modules that provide additional features, functionality and/or wired or wireless connectivity. For example, the peripherals 138 may include an accelerometer, an e-compass, a satellite transceiver, a digital camera (for photographs or video), a universal serial bus (USB) port, a vibration device, a television transceiver, a hands free headset, a Bluetooth® module, a frequency modulated (FM) radio unit, a digital music player, a media player, a video game player module, an Internet browser, and the like.

FIG. 1C shows an example RAN 104 and an example core network 1.06 that may be used within the communications system 100 shown in FIG. 1A. As noted above, the RAN 104 may employ an E-UTRA radio technology to communicate with the WTRUs 102a, 102b, 102c over the air interface 116. The RAN 104 may also be in communication with the core network 106.

The RAN 104 may include eNBs 140a, 140b, 140c, though it will be appreciated that the RAN 104 may include any number of eNBs while remaining consistent with an embodiment. The eNBs 140a, 140b, 140c may each include one or more transceivers for communicating with the WTRUs 102a, 102b, 102c over the air interface 116. In one embodiment, the eNBs 140a, 140b, 140c may implement MIMO technology. Thus, the eNB 140a, for example, may use multiple antennas to transmit wireless signals to, and receive wireless signals from, the WTRU 102a.

Each of the eNBs 140a, 140b, 140c may be associated with a particular cell (not shown) and may be configured to handle radio resource management decisions, handover decisions, scheduling of users in the uplink and/or downlink, and the like. As shown in FIG. 1C, the eNBs 140a, 140b, 140c may communicate with one another over an X2 interface.

The core network 106 shown in FIG. 1C may include a mobility management entity (MmE) 142, a serving gateway 144, and a packet data network (PDN) gateway 146. While each of the foregoing elements are depicted as part of the core network 106, it will be appreciated that any one of these elements may be owned and/or operated by an entity other than the core network operator.

The MME 142 may be connected to each of the eNBs 140a, 140b, 140c in the RAN 104 via an S1 interface and may serve as a control node. For example, the MME 142 may be responsible for authenticating users of the WTRUs 102a, 102b, 102c, bearer activation/deactivation, selecting a particular serving gateway during an initial attach of the WTRUs 102a, 102b, 102c, and the like. The MME 142 may also provide a control plane function for switching between the RAN 104 and other RANs (not shown) that employ other radio technologies, such as GSM or WCDMA.

The serving gateway 144 may be connected to each of the eNBs 140a, 140b, 140c in the RAN 104 via the S1 interface. The serving gateway 144 may generally route and forward user data packets to/from the WTRUs 102a, 102b, 102c. The serving gateway 144 may also perform other functions, such as anchoring user planes during inter-eNB handovers, triggering paging when downlink data is available for the WTRUs 102a, 102b, 102c, managing and storing contexts of the WTRUs 102a, 102b, 102c, and the like.

The serving gateway 144 may also be connected to the PDN gateway 146, which may provide the WTRUs 102a, 102b, 102c with access to packet-switched networks, such as the Internet 110, to facilitate communications between the WTRUs 102a, 102b, 102c and IP-enabled devices.

The core network 106 may facilitate communications with other networks. For example, the core network 106 may provide the WTRUs 102a, 102b, 102c with access to circuit-switched networks, such as the PSTN 108, to facilitate communications between the WTRUs 102a, 102b, 102c and traditional land-line communications devices. For example, the core network 106 may include, or may communicate with, an IP gateway, (e.g., an IP multimedia subsystem (IMS) server), that serves as an interface between the core network 106 and the PSTN 108. In addition, the core network 106 may provide the WTRUs 102a, 102b, 102c with access to the networks 112, which may include other wired or wireless networks that are owned and/or operated by other service providers.

It is desirable to provide a choice among using different information-centric network (ICN) architectures, such as a flooding-based content-centric network (FB-CCN) architecture and a distributed hash table (DHT) architecture. It is also desirable to be able to perform name resolution and routing in ICNs.

Content distribution and retrieval may be considered to be predominant features of the Internet. In content-oriented applications, an end user may care about a sought content, instead of a location of where the content is stored, (e.g., a host's IP address). However, today's IP networks may interconnect computing nodes, (e.g., terminals, servers, and the like), in which communications are based on a node's IP addresses in a host-to-host fashion. The foregoing discrepancy may cause inefficiencies in networks as well as in application designs.

Information-centric networking, also referred to as content-oriented networking, may be a useful Internet architecture to address the outlined discrepancy. An ICN may decouple content from its storage location at the network level and retrieve content objects using a content object's name, (e.g., identifier), instead of the IP addresses of its hosts. This networking may enable mechanisms, such as in-network caching and retrieval of content from the best location(s), to optimize bandwidth and improve content access performance. It also may free application developers from reinventing application-specific delivery mechanisms. An ICN may also solve and mitigate multi-homing and mobility support issues in the Internet.

ICN systems may face scalability and efficiency challenges in global deployments. The number of content objects may be huge, and may be rapidly growing. Based on the current Web size, an ICN system may be required to be able to handle at least 1012 objects by some estimates. Moreover, cyber-physical communication scenarios, such as wireless sensors and machine-to-machine (M2M), may be integrated into the Internet applications in the near future. Therefore, the number of global information objects may increase by at least several orders of magnitude. These objects may be stored at any location in the Internet, and may be created, replicated and deleted in a dynamic manner.

Bandwidth overhead may be decomposed into a part associated with data transportation and another part associated with content advertisement. By properly advertising content names, content routers (CRs) may be able to populate and dynamically update forwarding tables, as is performed by IP routing. Content advertisement may be different from IP routing in that the number of content objects may be much larger. Further, content advertisement may require different designs to cope with scalability. In particular, minimizing advertisement overhead may entail proper content object naming and name aggregation, similar to how IP addresses are handled.

An improvement in the scalability and efficiency of ICNs is desirable. The scalability and efficiency of ICNs may be affected by naming, name aggregation, and routing and name resolution schemes. A content object may be named more efficiently so that overhead is minimized when a names is used in content routing and name resolution. The names of content objects may be aggregated in publishing content locations, and content routing and name resolution may be optimized.

The mechanisms for content naming, routing and name resolution may vary depending upon the ICN architecture. In some ICNs, flat self-certifying names may be employed, whereas in others, a hierarchical naming scheme with binary-encoded uniform resource locators (URLs) may be used.

In content publishing, content availability may be announced to other content routers (CRs) via a traditional flooding protocol or a distributed hash table (DHT) scheme. To retrieve a content object, a request may be forwarded to the best content source(s) in the network employing either a direct name-based routing on the requested object identifier (ID) or a name resolution process that resolves an ID into a network location, (e.g., an IP address or a more general directive for forwarding).

However, there still lacks a quantitative model to characterize ICN architectures. For example, a quantitative model to characterize control of bandwidth overhead associated with a DHT and flooding may be lacking, as well as a quantitative model to characterize the impact of naming and name aggregation on scalability. Furthermore, the optimum way to name content objects with different popularities, (e.g., using a flat or a hierarchical naming scheme), is not yet known.

Information-centric networking has recently attracted research attention. An ICN may decouple content from hosts at a network layer and retrieve a content object by its name, (e.g., an ID), instead of its storage location, (e.g., host IP address), in order to address an IP network's limitations in supporting content distribution. However, ICN systems may face scalability and efficiency challenges in global deployments.

Optimal content naming is described herein, whereby a content object may be named based on its potential popularity. A shorter name may be given to a more popular content object to reduce advertising and querying overhead.

Optimal name aggregation is described herein, whereby content names may be aggregated in content advertising and publishing. The names of unpopular or transient content objects may be aggregated in order to save advertisement bandwidth.

Hybrid content routing and name resolution is also described herein. When location information of a content object is published by a node, the location information may be advertised to all the other CRs within a scope, (e.g., a local network or an autonomous system), on a condition that a utility function of the content object is greater than a threshold. Otherwise, the location information of the content object may only be advertised to a resolver. The utility function of a content object may be determined by the popularity of the content, object, network size, or the time that the content location changes. For example a utility function may be implemented such that the more popular a content object, the larger the utility, and the larger the network, the greater the utility. However other forms of the utility function, may be used. The resolver may be determined by a DHT scheme. When a CR receives a request for a content object, the resolver may check if it has the location information for the requested content. If not, the resolver may send a query or forward a request to the resolver of the content object.

In a flooding-based CCN (FB-CCN), each content router (CR), (i.e., a switching node), may be attached to content providers whose content IDs or names need to be advertised throughout the network by flooding techniques, similar to link state routing in an IP network so that other CRs in the network may know how to forward CRs to content sources based on the advertisements. Alternatively, a DHT network may incorporate a special type of node called a resolver. A CR may only advertise the location information of a content object, (i.e., content object ID, content provider ID or address that hosts this content object}, to a particular resolver determined by a hash value of the content ID. Further, any CR requesting the content ID may be required to consult with the same resolver to bind the content name and its location.

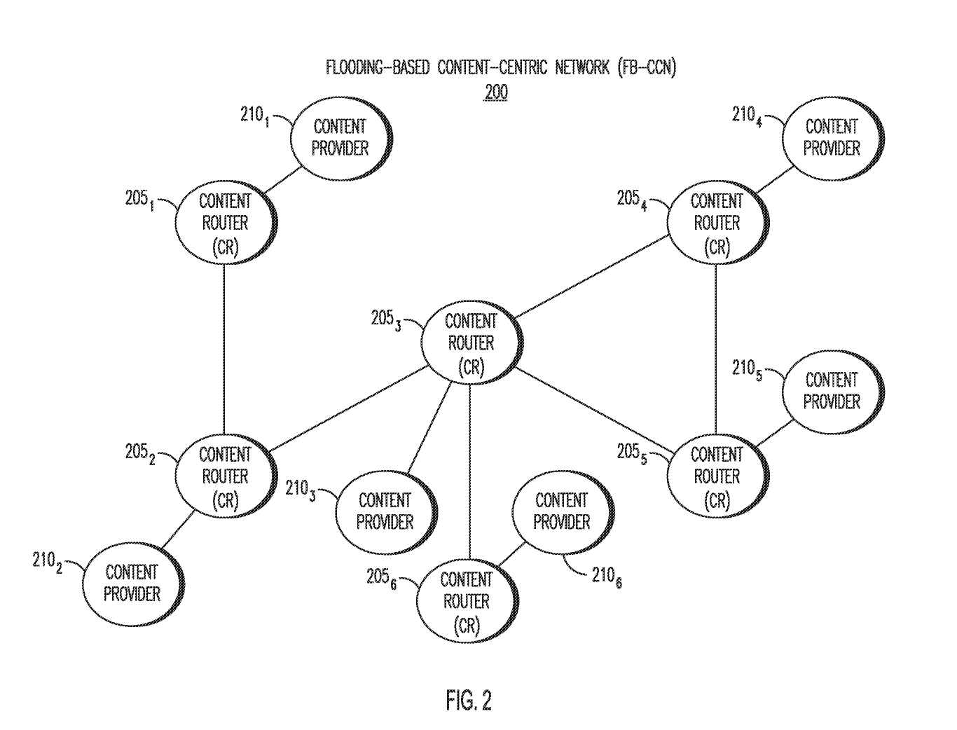

FIG. 2 shows an example of a FB-CCN 200 including a plurality of CRs 205₁, 205₂, 205₃, 305₄, 205₅, and 205₆, and respective content providers 210₁, 210₂, 210₃, 210₄, 210₅, and 210₆. In the CCN 200, each CR 205 advertises its knowledge of content object locations, (i.e., the content objects located in the CR's respective content provider 210), to all of the other CRs 205. The other CRs may store the received content location information advertisements, and use the information to build a content request forwarding table. When a CR receives a request for a content object, it may use the forwarding table to forward the request toward the content source.

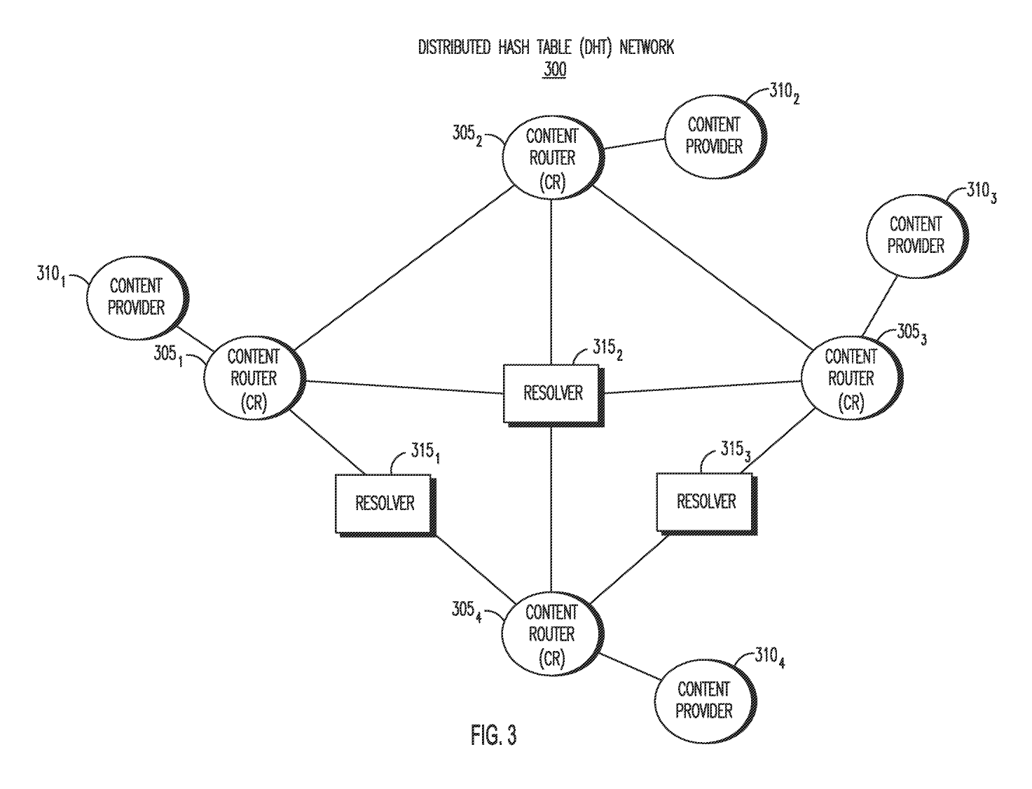

FIG. 3 shows an example of a distributed hash table (DHT) network 300 including a plurality of CRs 305₁, 305₂, 305₃, and 305₄, respective content providers 310₁, 310₂, 310₃, and 310₄, and resolvers 315₁, 315₂, and 315₃. Each CR 305 may inform a resolver 315 regarding the location of a particular content object in its respective content provider 310. The resolver may maintain the location information of a particular content object based on a DHT algorithm. The content ID may be the key of DHT. Thus, the location information of a content object, (i.e., content object ID, content provider ID or address that hosts this content object}, may be stored at the resolver that has a value with an ID (HASH(resolver ID) that is closest to but does not exceed the hash value of the content object ID (HASH(content object ID).

A CR, for example CR 305₁ shown in FIG. 3, may receive a request for a content object from a client (not shown). CR 305₁ may check whether the requested content is stored at a provider directly connected to it, or whether it has the location formation of the requested content object. If so, CR 305₁ may forward the request to the content provider 310₁. Otherwise, CR 305₁ may contact the resolver 315 responsible for this content object ID to obtain the content location information. When a resolver 315 receives a request for a content object from a CR 305, the resolver 315 responds to the CR 305 with information indicating a particular CR, for example CR 305₂, that has access to the content object, (i.e., in a respective content provider 310₂). The CR 305₁ may then forward the content request to the particular CR 305₂ to obtain the requested content object.

A content provider and a CR may be integrated into a single physical device, such that the CR has a storage unit to store or cache content and is a content provider or content source. Furthermore, a content router and a resolver may be integrated into a single physical device, such that the CR has a resolver function.

Optimal content naming is described herein. New content may be continually generated in an FB-CCN or a DHT network, and outdated content may be continually removed. In a steady state, there may be a constant need for publishing new content names at a certain rate, which may add a constant bandwidth overhead to the network, depending on lengths of the names and the manner of publication. Optimal content naming aims at minimizing bandwidth cost in either network architecture with given topology and traffic pattern. Specifically, in a network of N nodes and L links, and assuming that there are M content objects in the network labeled as c₁, c₂, . . . , c_{M}, the content objects' respective generation rate may be αᵢ and request rate may be λᵢ, for i=1, 2, . . . , M.

A content object cᵢ may have a name of Bᵢ bits. Alternatively, a content object cᵢ may have a name in the format of x₁/x₂/ . . . /x_{E} where xₖ (k=1, 2, . . . , E) is a subname. Further, each subname of the content object cᵢ may have a length of bᵢₖ bits.

The content request overhead c_{req} of a DHT network may be modeled as a product of message bandwidth and transmitted hop number in unit time, and may be represented as:

$${c}_{req} = {\sum }_{i = 1}^{M} {λ}_{i} {B}_{i} {\sum }_{j = 1}^{N} {p}_{ij} {h}_{ij} ; \qquad Equation ( 1 )$$

where

pᵢⱼ=prob(j sends the request|cᵢ is requested); Equation (2)

Where the probability (prob) of node j may send a request for content object cᵢ, and hᵢⱼ is the number of hops from j to the resolver of cᵢ.

Insertion overhead cᵢₙₛ (for example, a CR advertising to a resolver) may be modeled as the bandwidth-hop product consumed in unit time and represented as:

$${c}_{ins} = {\sum }_{i = 1}^{M} {α}_{i} {B}_{i} {\sum }_{j = 1}^{N} {p}_{ij}^{′} {h}_{ij} \qquad Equation ( 3 )$$

where

p′ᵢⱼ=prob(j inserts the content|cᵢ is inserted). Equation (4)

The probability of node j may publish/insert the content location information for content object cᵢ.

$$\begin{matrix}{c}_{req} = {\sum }_{i = 1}^{M} {B}_{i} {w}_{i} ; \\ where & Equation ( 5 ) \\ {w}_{i} = {\sum }_{j = 1}^{N} {q}_{ij} {h}_{ij} ; and & Equation ( 6 ) \\ {q}_{ij} = {λ}_{i} {p}_{ij} . & Equation ( 7 ) \\ Further , \\ {c}_{ins} = {\sum }_{i = 1}^{M} {B}_{i} {u}_{i} ; \\ where & Equation ( 8 ) \\ {q}_{ij}^{′} = {α}_{i} {p}_{ij}^{′} ; and & Equation ( 9 ) \\ {u}_{i} = {\sum }_{j = 1}^{N} {q}_{ij}^{′} {h}_{ij} . & Equation ( 10 )\end{matrix}$$

Consequently the total cost for DHT cₜₒₜ may be represented as:

$${c}_{tot} = {\sum }_{i = 1}^{M} {B}_{i} ( {w}_{i} + {u}_{i} ) . \qquad Equation ( 11 )$$

If content names are maintained at equal fixed lengths, then the best bandwidth efficient naming strategy may be to name each content object using a minimal number of bits. In order to differentiate M content objects, each name requires Bᵢ=log₂ M bits regardless of i. Consequently, the bandwidth overhead c*_{tot,fix} for DHT may be represented as:

$${c}_{tot , fix}^{*} = {log}_{2} M {\sum }_{i = 1}^{M} ( {w}_{i} + {u}_{i} ) ; \qquad Equation ( 12 )$$

where “fix” refers to all of the content objects that have the same fixed length. If variable name lengths are used, then the optimal naming strategy may set the Bᵢ bits to:

$${B}_{i} = - {log}_{2} \frac{{w}_{i} + {u}_{i}}{{\sum }_{j = 1}^{M} ( {w}_{j} + {u}_{j} )} ; \qquad Equation ( 13 )$$

and the minimal advertisement overhead may be represented as:

$${c}_{tot , var}^{*} = ( {\sum }_{i = 1}^{M} ( {w}_{i} + {u}_{i} ) ) H ( \frac{{w}_{1} + {u}_{1}}{{\sum }_{j = 1}^{M} ( {w}_{j} + {u}_{j} )} , … , \frac{{w}_{1} + {u}_{1}}{{\sum }_{j = 1}^{M} ( {w}_{j} + {u}_{j} )} ) ; where H ( \frac{{w}_{1} + {u}_{1}}{{\sum }_{j = 1}^{M} ( {w}_{j} + {u}_{j} )} , … , \frac{{w}_{1} + {u}_{1}}{{\sum }_{j = 1}^{M} ( {w}_{j} + {u}_{j} )} ) \qquad Equation ( 14 )$$

is the entropy, H( ), of the probability mass distribution.

As for FB-CCN, bandwidth overhead may be defined as the bandwidth-hop product consumed in unit time, whereby hierarchical names need to be flooded over an entire network. If the network consists of L links then the advertisement cost c_{adv} may be represented as:

$${c}_{adv} = {\sum }_{i = 1}^{M} {α}_{i} L {\sum }_{k = 1}^{E} {b}_{ik} . \qquad Equation ( 15 )$$

Assuming each subname, xᵢₖ, takes one of mₖ possible values and assuming that fixed subname lengths are used, then the minimal advertisement overhead may be represented as:

$${c}_{adv , fix}^{*} = L ( {\sum }_{i = 1}^{M} {α}_{i} ) ( {\sum }_{k = 1}^{E} {log}_{2} {m}_{k} ) ; \qquad Equation ( 16 )$$

which may be achieved by assigning bᵢₖ=log₂ mₖ bits to subname k regardless of i. If variable subname lengths are allowed then G_{gk} may be defined as:

G_{gk}={1≦i≦M,xᵢₖ takes the gth value}. Equation (17)

Content in G_{gk} may have for their kth subname of the same length, denoted by b′_{gk}.

By defining

$${y}_{k} = \frac{( ( {\sum }_{i ∈ {G}_{1 k}} {α}_{i} ) , … , ( {\sum }_{i ∈ {G}_{{m}_{k} k}} {α}_{i} ) )}{{\sum }_{i = 1}^{M} {α}_{i}} ; \qquad Equation ( 18 )$$

the most bandwidth efficient naming scheme may assign:

b′_{gk}=log₂ y; Equation (19)

and the minimal advertisement cost may be:

$${c}_{adv , var}^{*} = L ( {\sum }_{i = 1}^{M} {α}_{i} ) ( {\sum }_{k = 1}^{E} H ( {y}_{k} ) ) . \qquad Equation ( 20 )$$

Optimal name aggregation is described herein. To cope with scalability issues inherent in the content oriented networks, Bloom filter are introduced to generate summarization for name aggregates. Each Bloom filter is specified by three parameters. The three parameters are the number of aggregated content names, M, the filter length of m bits and the number of hash functions, k. An optimal setting of m and k is identified given M and traffic patterns for the content object. For DHT, Bloom filter summarization may be used in resolvers instead of content names, and only content objects belonging to the same resolver may be aggregated.

In a FB-CCN, assuming the first J subnames are the same such that they form a common prefix, a different Bloom filter may be associated for subname J+1 through subname E. However, this may not be necessary and a single Bloom filter may generate equally sufficient summarization.

For optimal name aggregation in a DHT network, a fixed length naming of B bits per name is assumed. For optimal name aggregation in a FB-CCN, a fixed naming of Bₖ bits for each subname xᵢₖ is assumed. Further, it is noted that the purpose of optimal name aggregation is to find, in either a DHT network or a FB-CCN, the optimal number of hash functions, the optimal length of Bloom filter summarization, the cost under these optimal settings and, consequently, the decision procedure as to determine whether aggregation or non-aggregation on a given set of content files may be performed.

For a DHT network, the summarization may incur ambiguity over M′ content objects. Thus, although summarization is generated from M(<M′) content objects, it may be confused with another M′−M content objects for which a resolution error may occur at the resolver. The ensemble request rate for the M′−M ambiguous content objects may be λₛ, and insertion may be repeated every T seconds.

When b=BλₛT; and Equation (21)

$$ρ = \frac{b}{MB} < 1 \qquad Equation ( 22 )$$

the best aggregation strategy may be to drop content without advertising the content.

When

$$ρ = \frac{b}{MB} > 1 , \qquad Equation ( 23 )$$

the optimal number of hash functions may be given as:

$${k}^{*} = \frac{m}{M} log 2 ; \qquad Equation ( 24 )$$

and the optimal filter length may be given as:

$${m}^{*} = \frac{M log \frac{{log}^{2} 2 b}{M}}{{log}^{2} 2} . \qquad Equation ( 25 )$$

Further, aggregation may be more advantageous than non-aggregation if the name length is larger than a threshold given by:

Mₘₐₓ≈2.0814 log(eρlog₂(eρ); Equation (26)

where ρ is defined in Equation (23) and e is Euler's number.

For an FB-CCN, a similar conclusion may be drawn, whereby only one Bloom filter summarization may be sufficient. Assuming that the average hops from a switching node to a resolver may be given by h̅, then the best number of hash functions and filter length may be calculated using the same formula as shown in Equations (24) and (25) if the following are defined:

$$\begin{matrix}m = {\sum }_{j = J + 1}^{E} {m}_{j} ; & Equation ( 27 ) \\ B = {\sum }_{j = J + 1}^{E} {B}_{j} ; and & Equation ( 28 ) \\ b = \frac{B {λ}_{s} T \overline{h}}{L} . & Equation ( 29 )\end{matrix}$$

A predetermined threshold for determining FB-CCN or DHT may be utilized for performing name resolution. Based on advertisement overhead, there may be a predetermined threshold that assists in choosing between a FB-CCN and a DHT network. Further, the FB-CCN architecture or the DHT network architecture may be superior according to a threshold that is determined by network topology and traffic pattern, assuming that optimal variable-length naming schemes are used for both architectures.

If

$$λ = {\sum }_{i = 1}^{M} {λ}_{i}$$

denotes the ensemble content request rate, (i.e., the average number of content objects requested in unit time),

$$α = {\sum }_{i = 1}^{M} {α}_{i}$$

may denote the ensemble content generation rate, (i.e., the average number of content objects generated in a unit time), and K may denote the average degree of a CR, i.e. the average number of neighboring nodes). Then, the utility function may be dependent on the network topology, and traffic pattern and may be given as:

$$utility = \frac{α}{λ} ( \frac{( log K ) \times NK}{2 log N} - 1 ) ; \qquad Equation ( 30 )$$

where N is the total number of nodes in the network.

If utility is larger than one, then a DHT network may be superior. If utility is smaller than one, then an FB-CCN may be superior. Thus, in a large network with relatively unpopular content objects, a DHT network may be superior. Otherwise, a FB-CCN may be superior. This observation enables the possibility of hybrid architecture design where, on the area-level, a FB-CCN may be used for its potentially intensive localized content requests, while on the domain level, a DHT network may be used for its ability to accommodate a larger number of content objects.

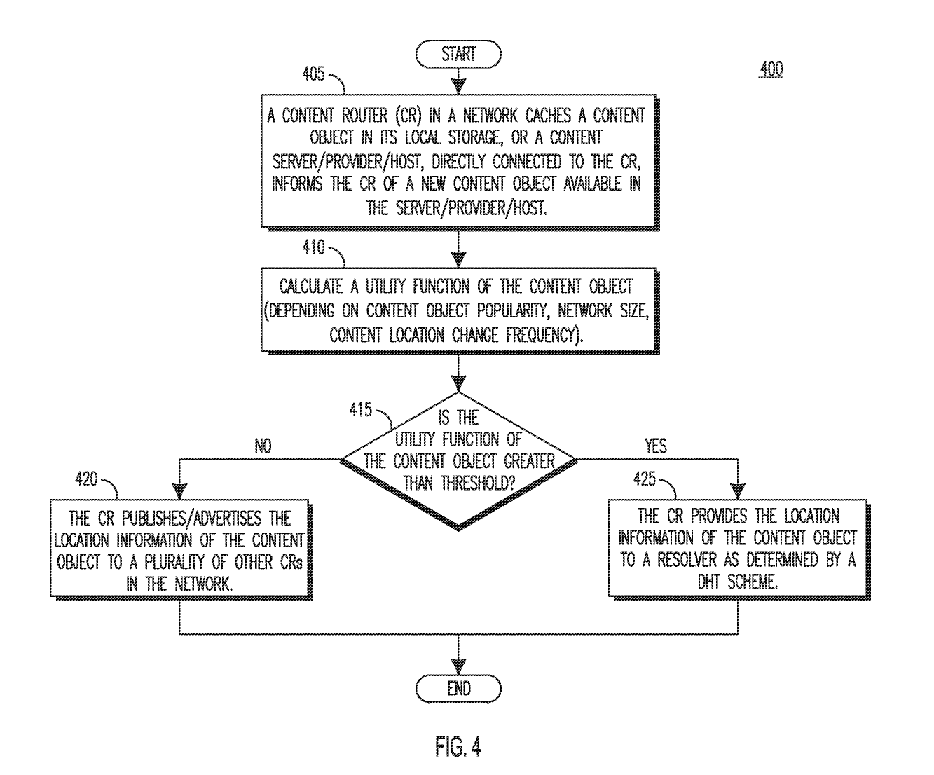

FIG. 4 is a flow diagram of an example hybrid content publishing procedure 400 for a content router (CR) in a network to publish the location reachability information of a content object. In the procedure 400, the CR may cache a content object in its local storage, or a content server/provider/host that is directly connected to the CR may inform the CR of a new content object available in the content server/provider/host (405). A utility function of the content object may be calculated (410), (depending on content object popularity, network size, or content location change frequency). A determination may be made as to whether or not the utility function of the content object is greater than a threshold (415). If the utility function of the content object is not greater than the threshold, the CR may publish/advertise the location information of the content object to a plurality of other CRs in the network (420). If the utility function of the content object is greater than the threshold, the CR may provide the location information of the content object to a resolver as determined by a DHT scheme (425).

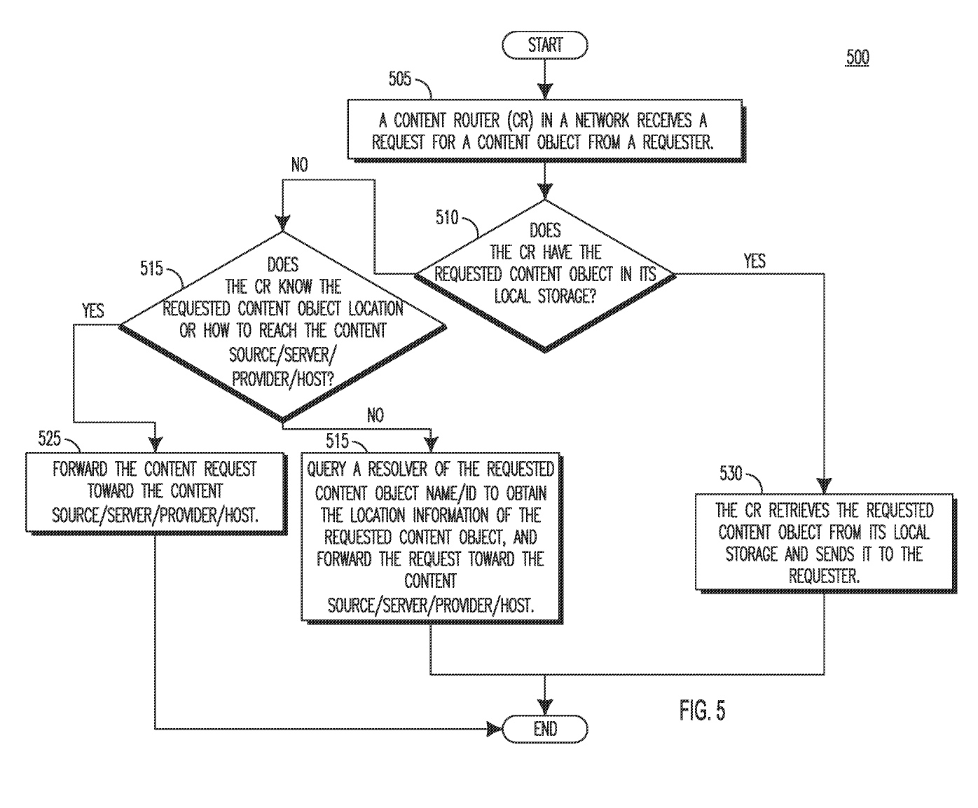

FIG. 5 is a flow diagram of an example procedure 500 for a CR in a network to forward a request for a content object from a requester. In the procedure 500, the CR may receive a request for a content object from a requester (505). If the CR does not have the requested content object in its local storage (510), and does not know the requested content object location or how to reach the content source/server/provider/host (515), the CR may query a resolver of the requested content object name/ID to obtain the location information of the requested content object, and forward the request toward the content source/server/provider/host (520). If the CR knows the requested content object location or how to reach the content source/server/provider/host (515), the CR may forward the content request toward the content source/server/provider/host (525). If the CR has the requested content object in its local storage (510), the CR may retrieve the requested content object from its local storage and send it to the requester (530).

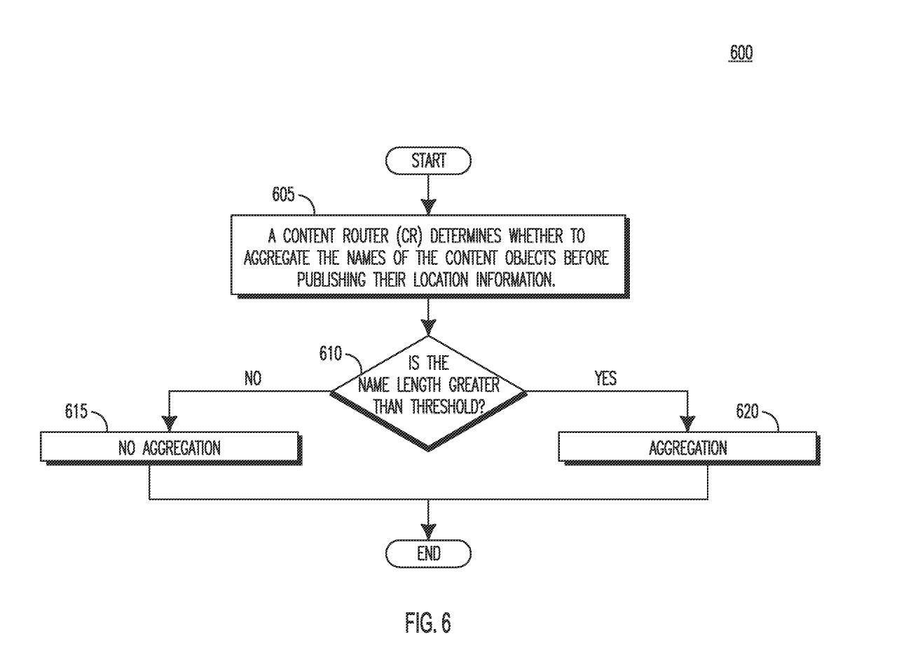

FIG. 6 is a flow diagram of an example procedure 600 used to determine whether to aggregate the content names before publishing them using a flooding scheme or DHT scheme. In procedure 600, the CR may determine whether to aggregate the names of the content object names before publishing their location information (605). If the name length is not greater than a threshold (610), the CR may not aggregate the name (615). If the name length is greater than the threshold (610), the CR may aggregate the name (620).

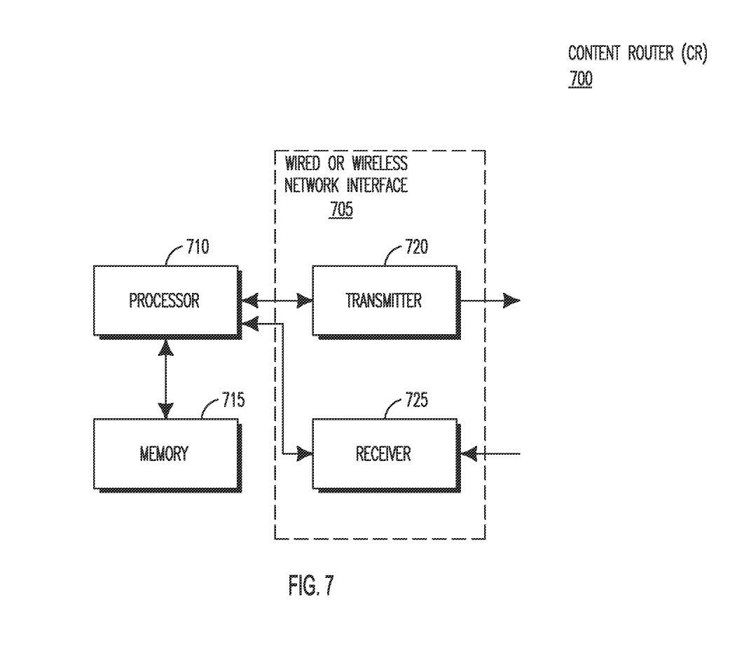

FIG. 7 shows an example block diagram of a CR 700 including at least one network interface 705, a processor 710, and a memory 715. The network interface 705 may include a transmitter 720 and a receiver 725. The network interface 705 may be a wired or wireless network interface. The network interface 705 may be configured to receive a request for a content object. The processor 710 may be configured to determine whether the CR 700 has the requested content object in a storage directly connected to it, or know the location of the requested content object. The network interface 705 may be further configured to query a resolver of the requested content object ID, obtain the location information of the requested content object and forward the request toward the content source/provider. The processor 710 may further be configured to determine whether to aggregate content object names before publishing their location information based on whether or not the name length is greater than a threshold. If the name length is not greater than the threshold, content object name aggregation is not performed. Otherwise, the content object names are aggregated.

Although features and elements are described above in particular combinations, one of ordinary skill in the art will appreciate that each feature or element may be used alone or in combination with any of the other features and elements. In addition, the embodiments described herein may be implemented in a computer program, software, or firmware incorporated in a computer-readable medium for execution by a computer or processor. Examples of computer-readable media include electronic signals, (transmitted over wired or wireless connections), and computer-readable storage media. Examples of computer-readable storage media include, but are not limited to, a read only memory (ROM), a random access memory (RAM), a register, a cache memory, a semiconductor memory device, a magnetic media, (e.g., an internal hard disc or a removable disc), a magneto-optical media, and an optical media such as a compact disc (CD) or a digital versatile disc (DVD). A processor in association with software may be used to implement a radio frequency transceiver for use in a WTRU, UE, terminal, base station, Node-B, eNB, HNB, HeNB, AP, RNC, wireless router or any host computer.

What is claimed is:

1. A method of publishing location information for a content object, the method comprising:
a content router (CR) in a network receiving a request for a content object;
the CR determining a utility function of the content object; and
the CR comparing the utility function to a predetermined threshold.

2. The method of claim 1 further comprising:
the CR advertising location information of the content object to a plurality of other CRs in the network on a condition that the utility function is not greater than the predetermined threshold.

3. The method of claim 1 further comprising:
the CR providing location information of the content object to a resolver as determined by a distributed hash table (DHT) scheme on a condition that the utility function is greater than the predetermined threshold.

4. The method of claim 3 wherein the CR advertises the location information to a particular resolver determined by a hash value of the content object.

5. The method of claim 1 wherein the length of a name of the content object is based on the popularity of the content object.

6. The method of claim 5 wherein popular content objects are provided with shorter name lengths than less popular content objects.

7. The method of claim 5 wherein the names of less popular content objects are aggregated to reduce advertising and querying overhead.

8. A method of publishing location information for a content object, the method comprising:
a content router (CR) in a network receiving a request for a content object;
the CR querying a resolver associated with an identity (ID) of the requested content object to obtain location information of the requested content object, on a condition that the CR does not have access to the requested content object; and
forwarding the request to a content source identified by the location information.

9. The method of claim 8 further comprising:
the CR advertising location information of the content object to a plurality of other CRs in the network.

10. The method of claim 8 further comprising:
the CR providing location information of the content object to the resolver as determined by a distributed hash table (DHT) scheme.

11. The method of claim 10 wherein the CR advertises the location information to a particular resolver determined by a hash value of the content object.

12. The method of claim 8 wherein the length of a name of the content object is based on the popularity of the content object.

13. The method of claim 12 wherein popular content objects are provided with shorter name lengths than less popular content objects.

14. The method of claim 12 wherein the names of less popular content objects are aggregated to reduce advertising and querying overhead.

15. A content router (CR) comprising:
a network interface configured to receive a request for a content object; and
a processor configured to determine a utility function of the content object, and comparing the utility function to a threshold.

16. The CR of claim 15 wherein the network interface is further configured to advertise location information of the content object to a plurality of other on a condition that the utility function is not greater than the predetermined threshold.

17. The CR of claim 15 wherein the network interface is further configured to provide location information of the content object to a resolver as determined by a distributed hash table (DHT) scheme on a condition that the utility function is greater than the predetermined threshold.

18. The CR of claim 17 wherein the first CR advertises the location information to a particular resolver determined by a hash value of the content object.

19. The CR of claim 15 wherein the length of a name of the content object is based on the popularity of the content object.

20. The CR of claim 15 wherein popular content objects are provided with shorter name lengths than less popular content objects.

21. The CR of claim 15 wherein the names of less popular content objects are aggregated to reduce advertising and querying overhead.
